(19) United States
(12) Patent Application Publication
(10) Pub. No.: US 2020/0275783 A1
(43) Pub. Date: Sep. 3, 2020

(54) Shoulder Neutral Positioning Pillow

(71) Applicant: Dallas Williams, Huntsville, TX (US)

(72) Inventor: Dallas Williams, Huntsville, TX (US)

(21) Appl. No.: 16/290,487

(22) Filed: Mar. 1, 2019

(51) Int. Cl. A47C 20/02; A61G 7/075

(52) U.S. Cl. CPC A47C 20/023; A61G 7/075

(57) ABSTRACT

A support apparatus for positioning an individual's arm while the individual is in a supine position comprising a first portion configured to rest across the midsection of an individual's body and a second portion configured to rest alongside the individual's upper body. The first portion and the second portion both comprise a top surface and a bottom surface and at least one of the top surface of the first portion and the top surface of the second portion are further indented to receive one or more parts of the individual's arm. The bottom surface of the first portion is further indented to receive the individual's midsection. The configuration of the first portion and the section portion of the support apparatus further enables the individual's shoulder to be positioned in a neutral position.

### BACKGROUND

It is often necessary or recommended for individuals to immobilize parts of their bodies after undergoing surgical procedures or recovering from certain injuries. One of the most common procedures that require such immobilization is rotator cuff shoulder surgery. The recovery period for rotator cuff surgery includes a protective phase beginning immediately after surgery and lasting between four to eight weeks, depending on the surgeon. During this protective phase, the surgeon wants to prevent any active movement of the glenohumeral joint (GHJ) because such movement could lead to disruption of the repair. While various support pillows and slings exist to help immobilize the shoulder, individuals find these existing pillows and slings to be cumbersome, uncomfortable, and ineffective at immobilizing the shoulder. In fact, individuals find that it is nearly impossible to sleep comfortably even in their own bed for weeks and even months after their surgery because any light stretch, stress, or tension on any of the capsular structures, or rotator cuff tendons can cause pain, preventing the individual from relaxing.

There exists a need for a support pillow or apparatus that is configured to enable an individual to lye in a supine position and rest comfortably while maintaining GHJ neutral. As used herein, “neutral position” refers to positioning the GHJ joint at approximately 55° abduction, 30° horizontal adduction, and neutral rotation. This neutral position is sometimes referred to as the “open pack” position by surgeons and physical therapists. It is the most optimal position for the shoulder to be in while healing from injury or surgery because it places all of the RTC tendons, joint capsule, and ligament structures in their most “slack” position.

Current designs for pillows and slings are not effective in placing the shoulder in a neutral position to aid in healing. These current designs are also not effective in helping an individual sleep or rest and are often bulky, uncomfortable, and cumbersome to wear or use. Individuals are forced to try to arrange and shape bed pillows into a supportive position in an attempt to achieve a neutral and comfortable position. This approach is not an effective, reliable, or clinically accurate means for individuals to achieve a neutral position after surgery or injury, promote healing and recovery, and rest comfortably while on their backs.

### SUMMARY

The present disclosure provides for a support apparatus for positioning an individual's arm while the individual is lying on their back in a supine position. The support apparatus comprises a first portion which is designed to rest across the midsection of an individual's body and a second portion which is designed to rest alongside the individual's upper body. A top surface of at least one of the first portion and the second portion may be indented to receive various parts of the individual's arm. A bottom surface of the first portion may also be indented to permit the first portion to comfortably rest on top of the individual. A bottom surface of the second portion may be flat to make contact with the bed, couch, chair, floor, or other surface upon which the individual is laying and stabilize the support apparatus.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 is illustrative of a support apparatus of the present disclosure.

FIG. 2 is illustrative of a support apparatus of the present disclosure where the support apparatus is configured with a handle and a lift mechanism.

FIG. 3 is illustrative of the positioning of an individual's arm using a support apparatus of the present disclosure.

FIG. 4 is illustrative of the positioning of an individual's arm using a support apparatus of the present disclosure.

FIG. 5 is illustrative of the positioning of an individual's arm using a support apparatus of the present disclosure.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

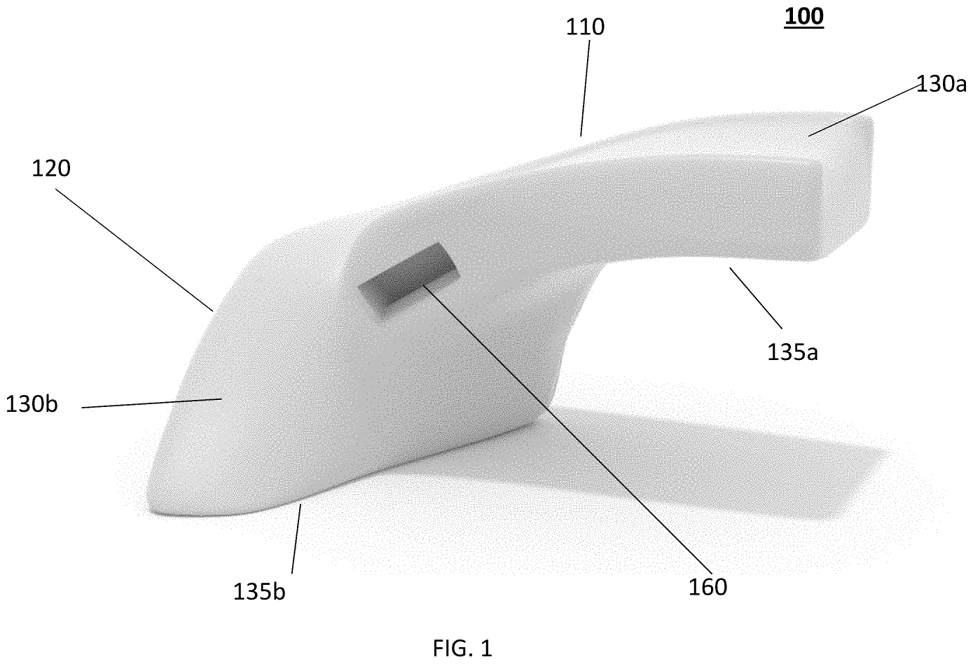

The present disclosure provides for a support apparatus designed to position an individual's arm so that the shoulder is in a neutral position while the individual is lying down in a supine position. As stated above, this critical neutral position is achieved by securing the shoulder in a position of 55° abduction, 30° horizontal adduction, and neutral rotation. It is contemplated that this support apparatus be comprised of a foam material or other similar material that is strong enough to provide support but flexible and light enough to ensure the individual is comfortable and can easily transport the support apparatus. One embodiment of such a support apparatus is illustrated in FIG. 1. In such an embodiment, the support apparatus 100 comprises a first portion 110 which is configured to rest across the midsection of an individual's body. This first portion 110 may comprise a top surface 130(a) and a bottom surface 135(a). The top surface 130(a) may be indented to receive a portion of an individual's arm, for example the lower portion of the arm, such as from the elbow to the fingers. The bottom surface 135(a) may be indented to receive the individual's midsection.

A second portion 120 of the support apparatus 100 is configured to rest alongside of an individual's upper body. This section portion 120 may also comprise a top surface 130(b) and a bottom surface 135(b). The top surface 130(b) may be indented to receive a portion of the individual's arm, for example the upper portion of the arm, such as from the shoulder to the elbow.

The bottom surface 135(b) of the section portion 120 is intended to provide stability and support to the support apparatus 100 and therefore is designed to rest on top of a bed, chair, or other surface the individual is lying on.

In one embodiment, illustrated by FIG. 1, the support apparatus 100 is configured with a handle 160. This handle 160 is provided to aid in transporting as well as arranging the support apparatus 100. This sloping design not only assists in securing the individual's shoulder in the neutral position, but also provides for a comfortable position for the individual to rest in. The fact that the top surface of both the first portion 130(a) and the top surface of the second portion 130(b) are both indented, also aids in securing the individual's shoulder in the neutral position. Unlike support pillows, where an individual's arm can easily slide off, these indentations ensure that the individual's arm and as a result its shoulder is secure in position. This is because the indentations create essentially walled sides that the individual's arm cannot slip past. These walled sides eliminate the need for an uncomfortable sling or other similar apparatus for keeping the individual's arm in place.

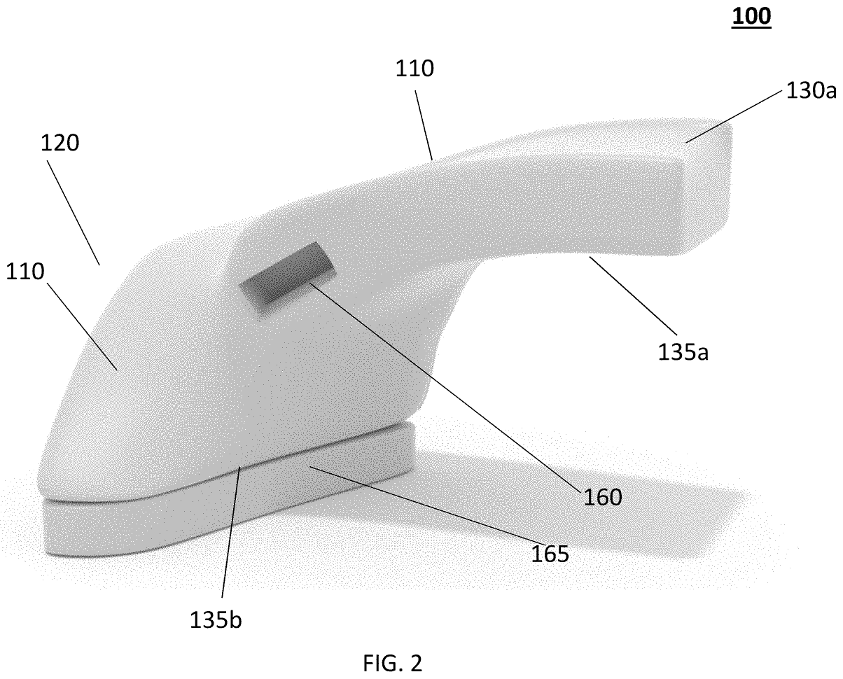

Another optional feature of the Support Device 100 is illustrated in FIG. 2. Here, the support apparatus 100 is further configured with one or more lift mechanisms 165. The lift mechanism 165 may be affixed to the bottom surface of the second portion 135(b) to thereby increase the distance between any surface the support apparatus 100 is resting on and the bottom surface of the first portion 135(a). These lift mechanism may be used when an individual has a thick torso or long limbs and such extra distance is needed to ensure the individual is comfortable and that the shoulder is secured in the proper neutral position.

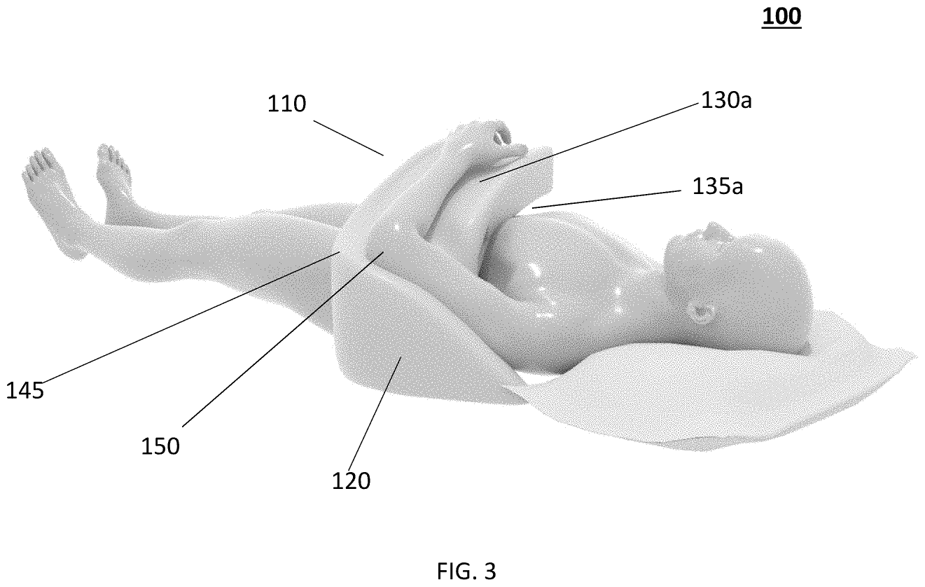

FIG. 3 is illustrative of the positioning of an individual's arm using a support apparatus of the present disclosure. As can be seen in FIG. 3, the first portion 110 and the second portion 120 of the support apparatus 100 are joined at an angle 145 that permits the individual's elbow 150 to rest in a bent position in the range of approximately 90°-100°. This positioning is critical to achieving the desired neutral position of the shoulder.

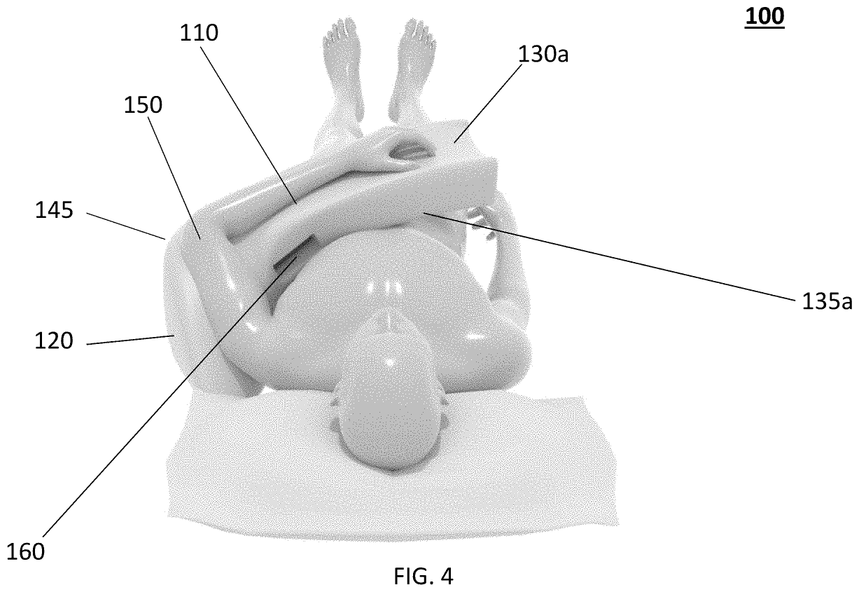

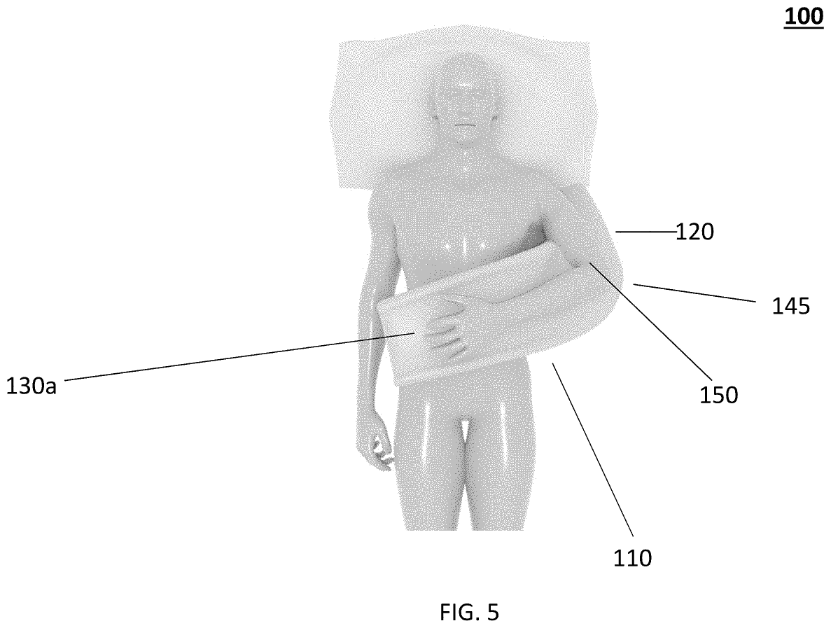

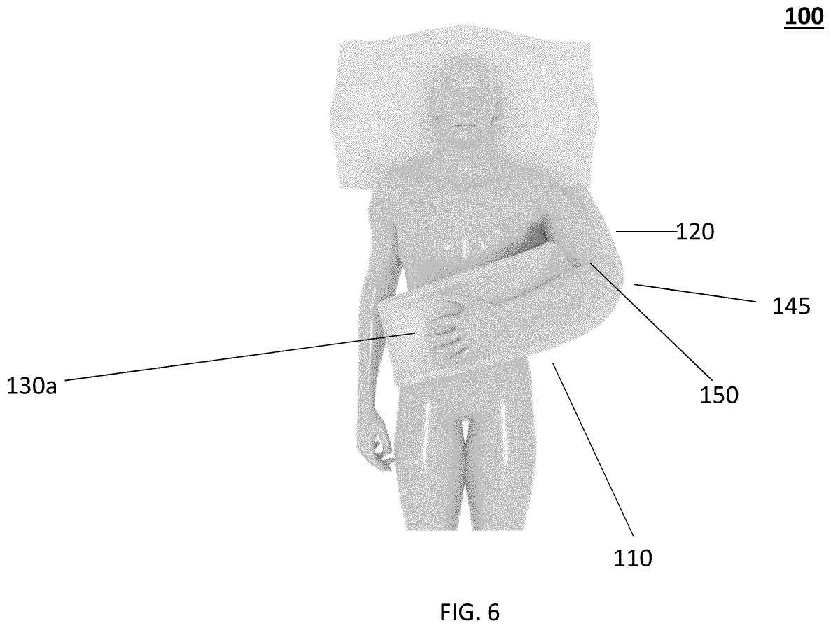

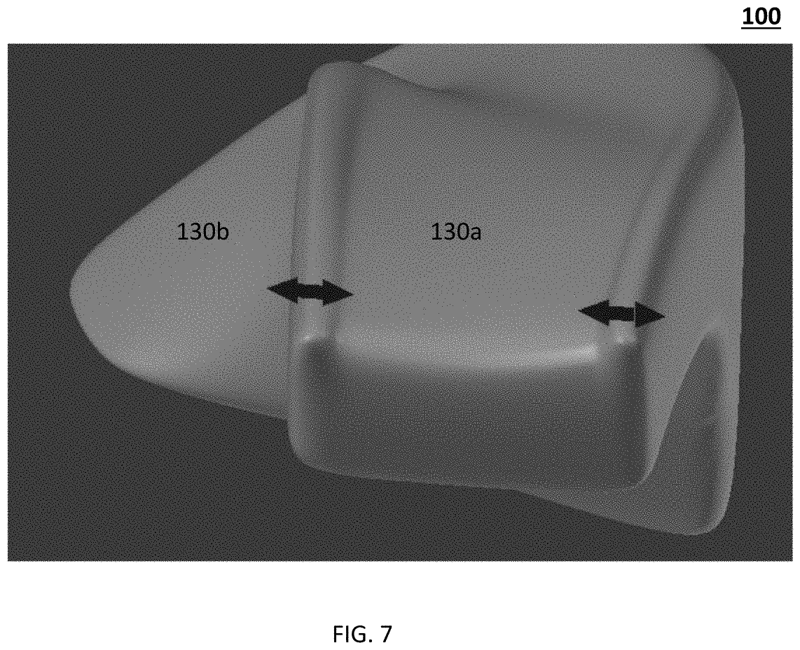

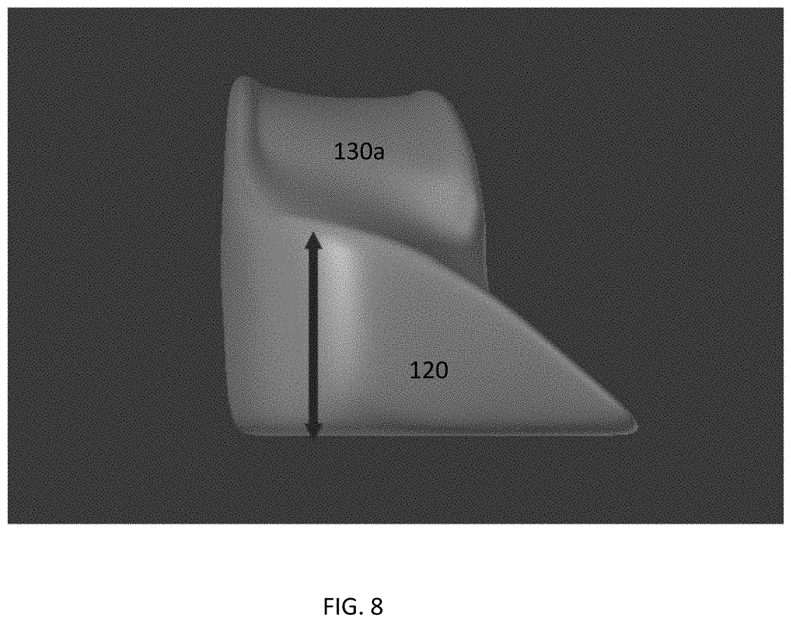

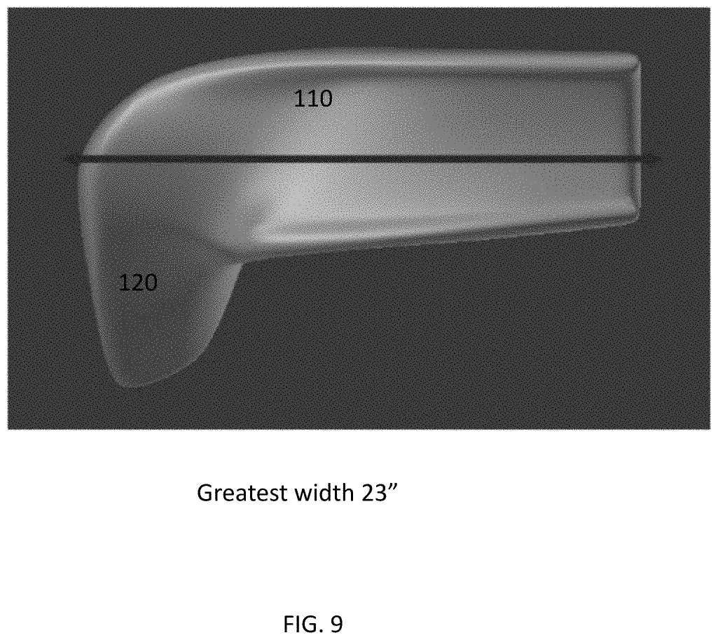

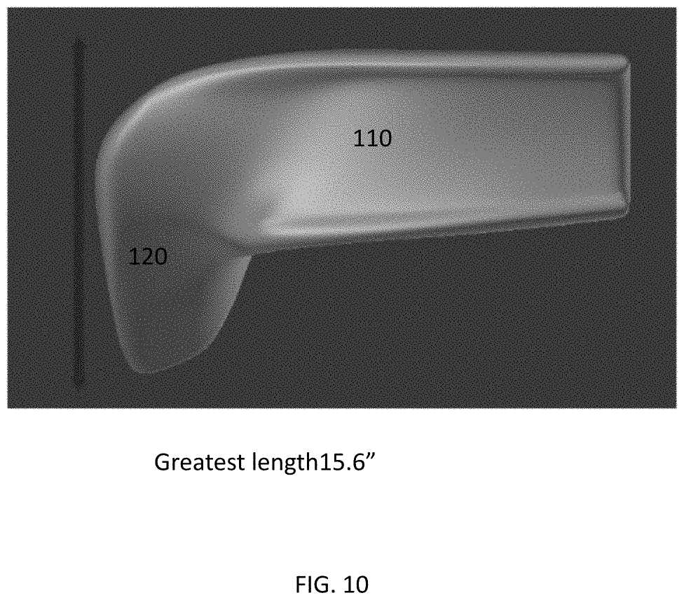

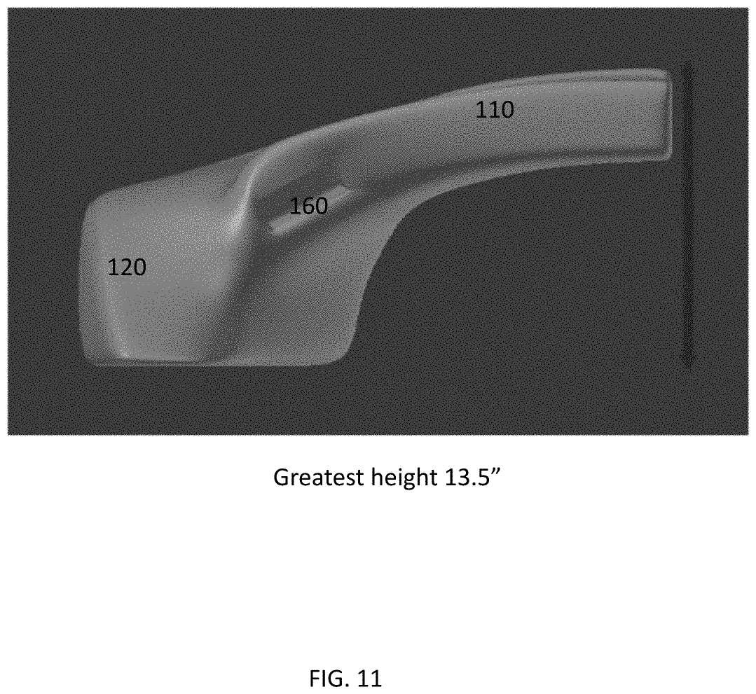

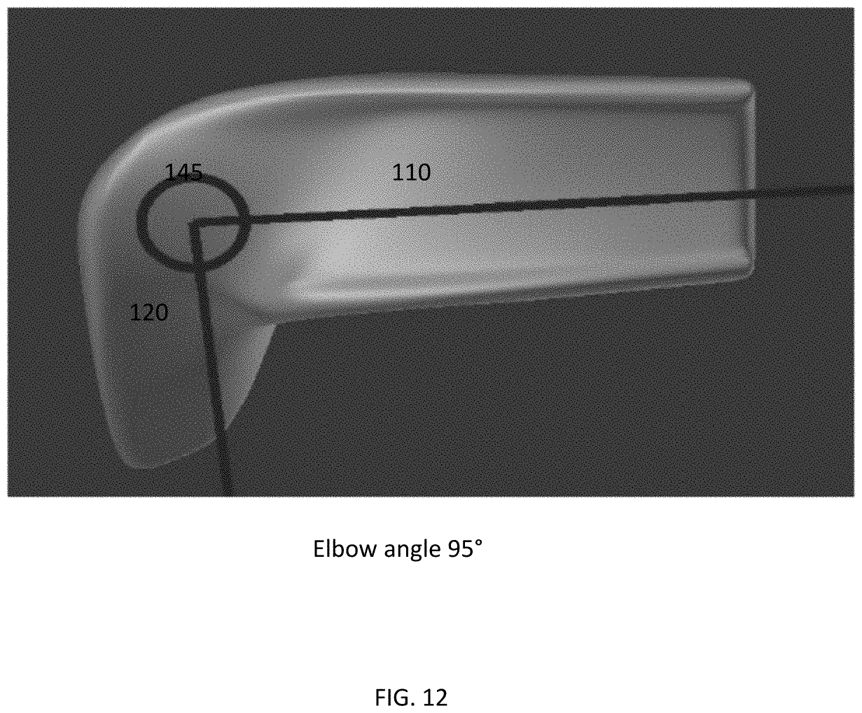

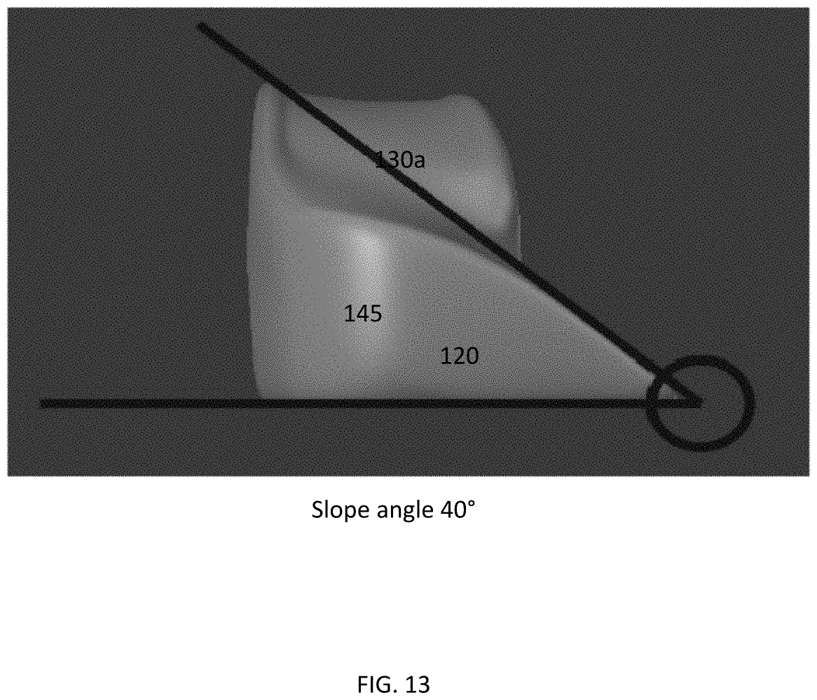

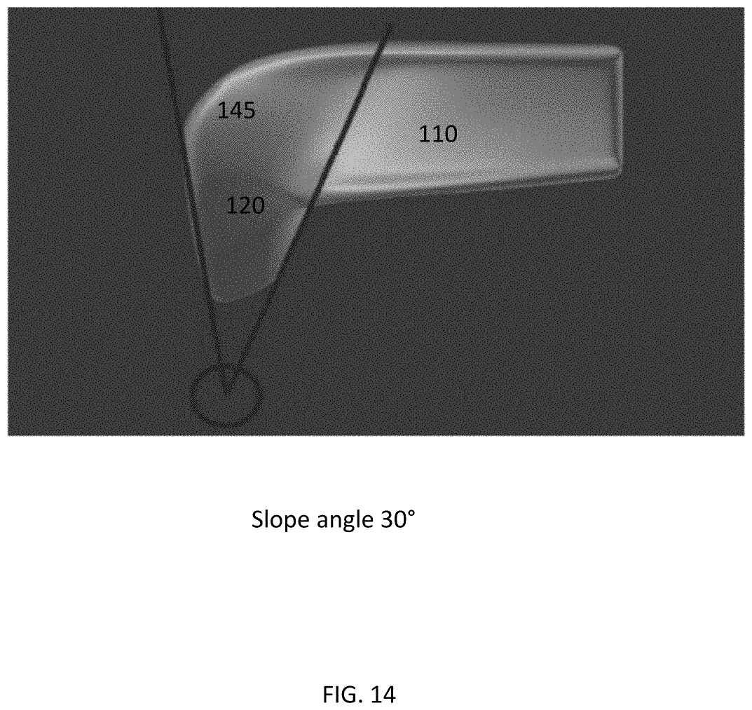

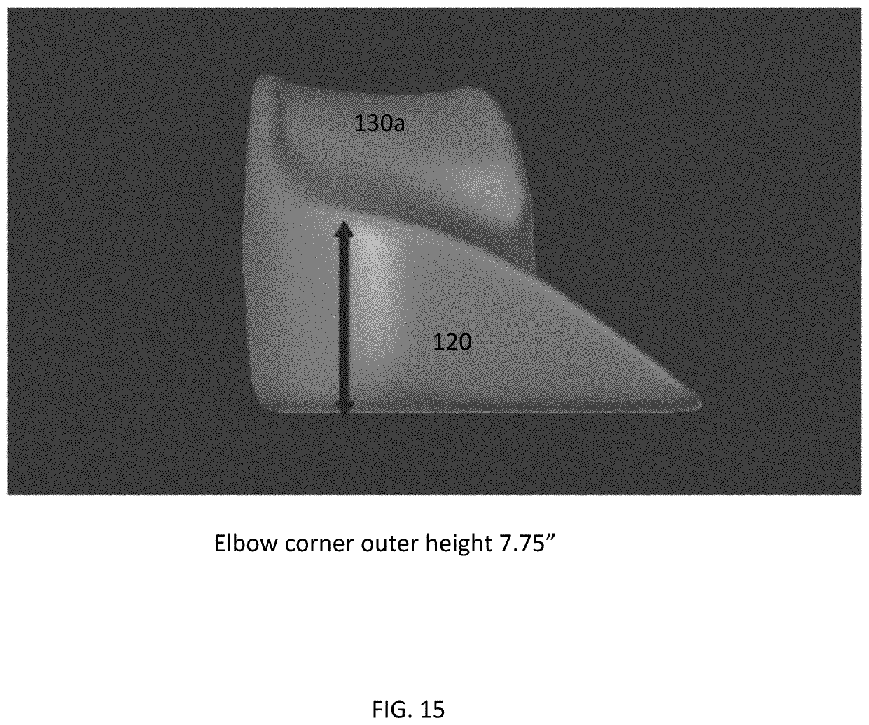

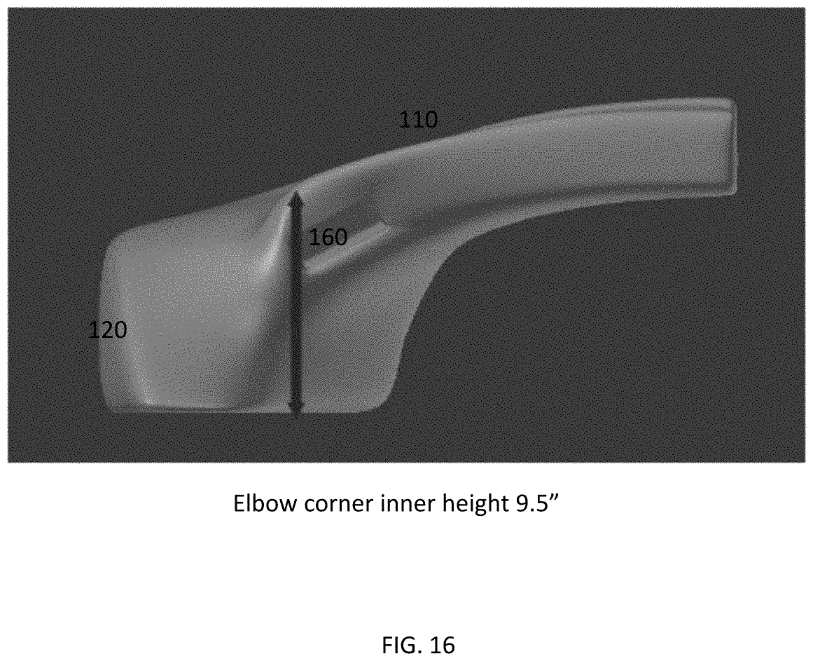

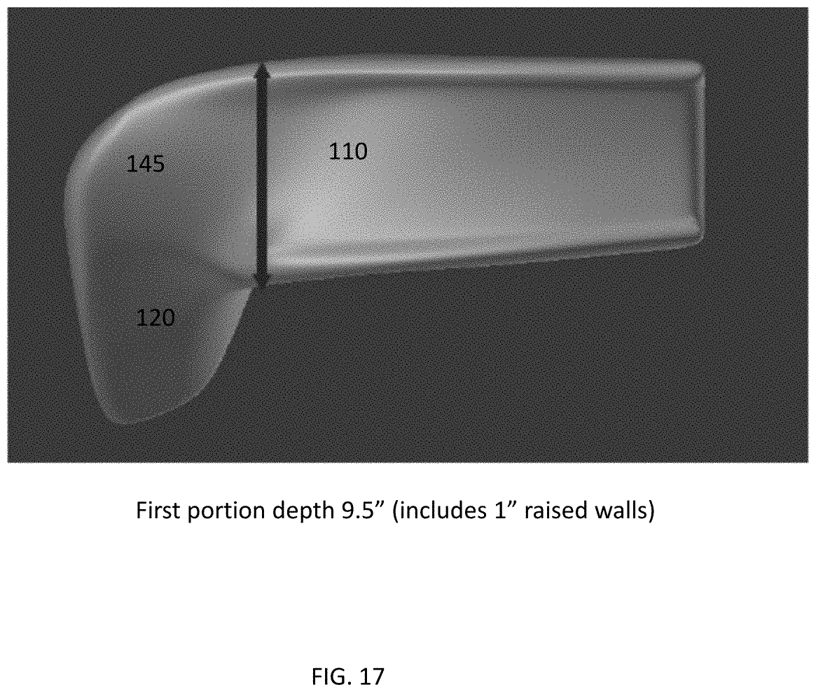

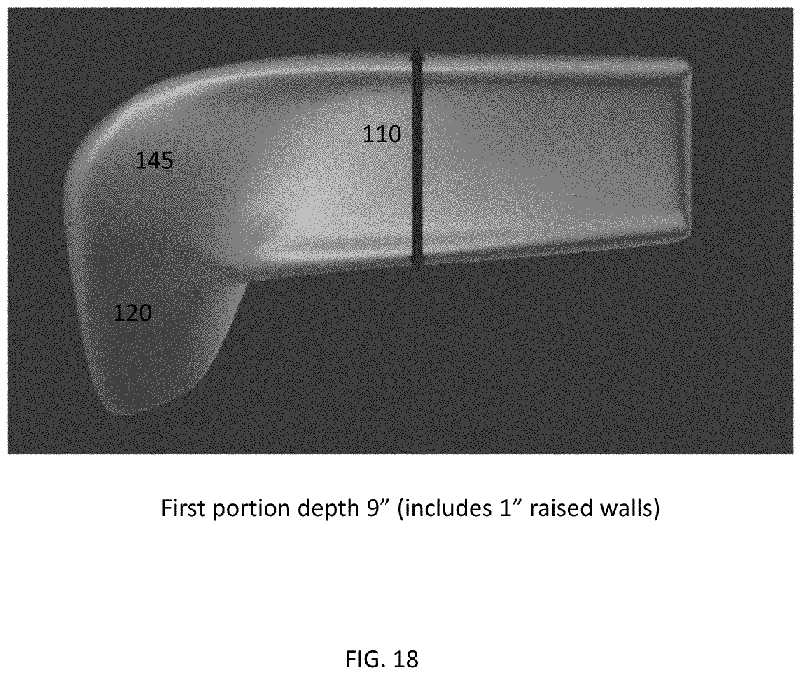

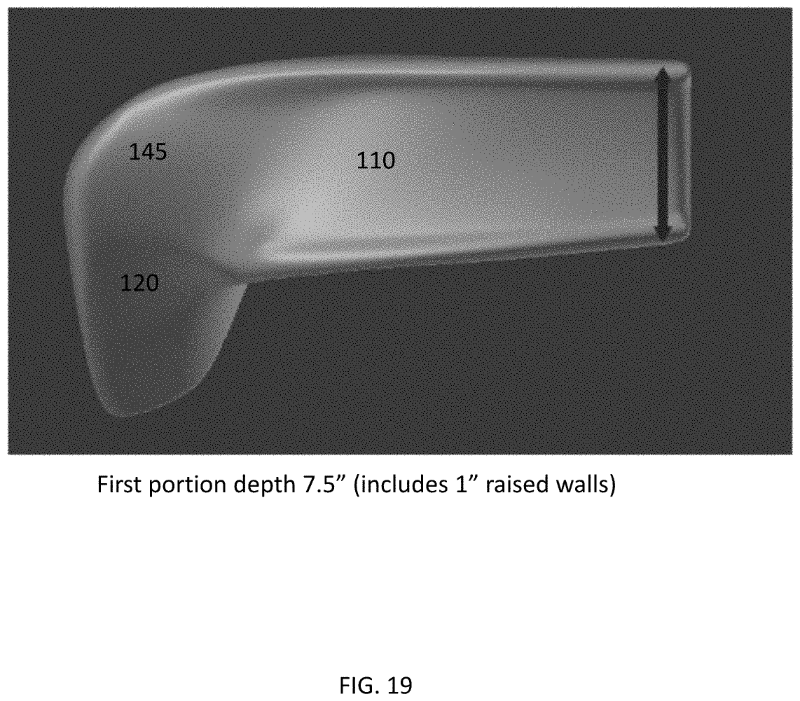

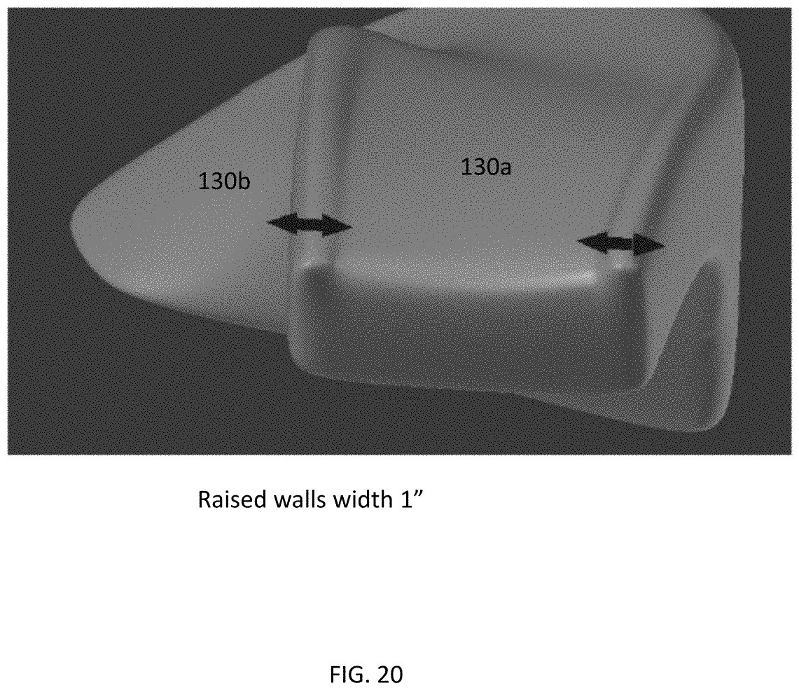

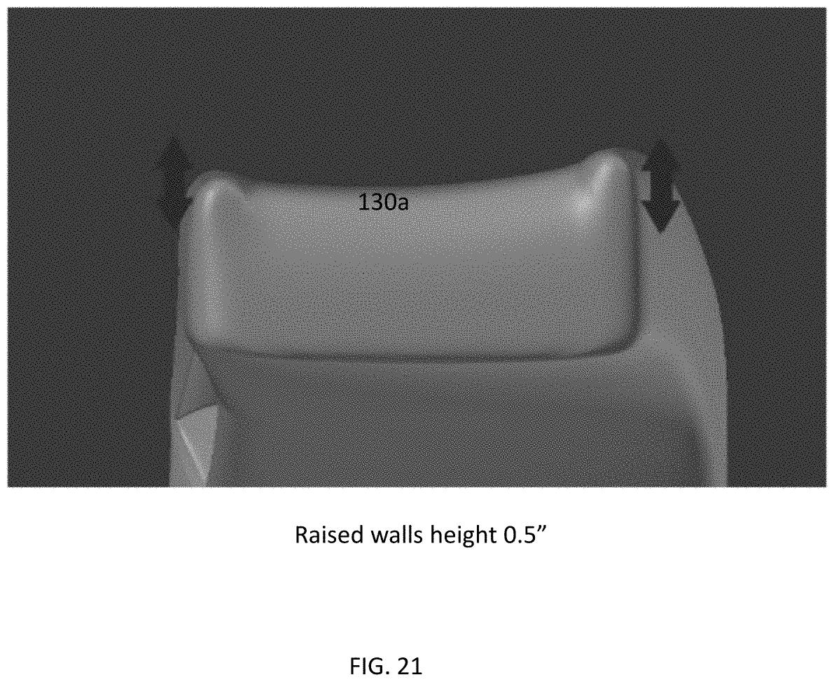

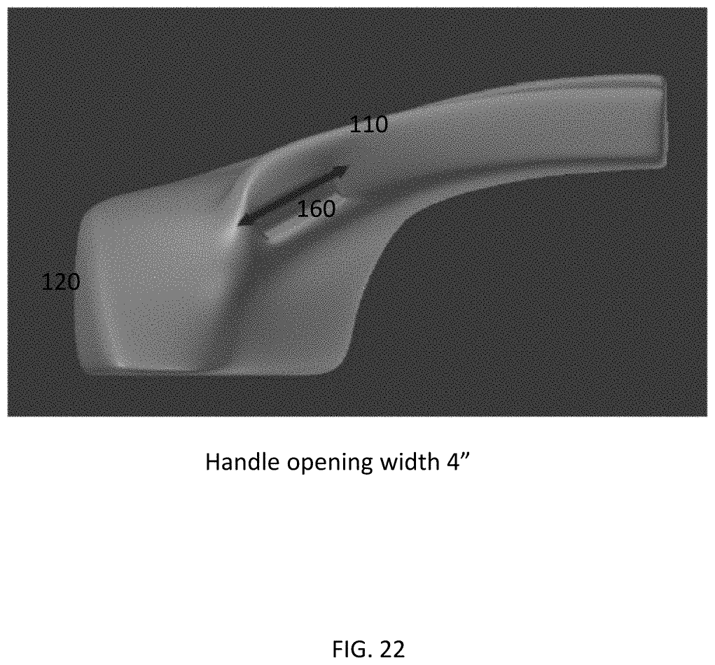

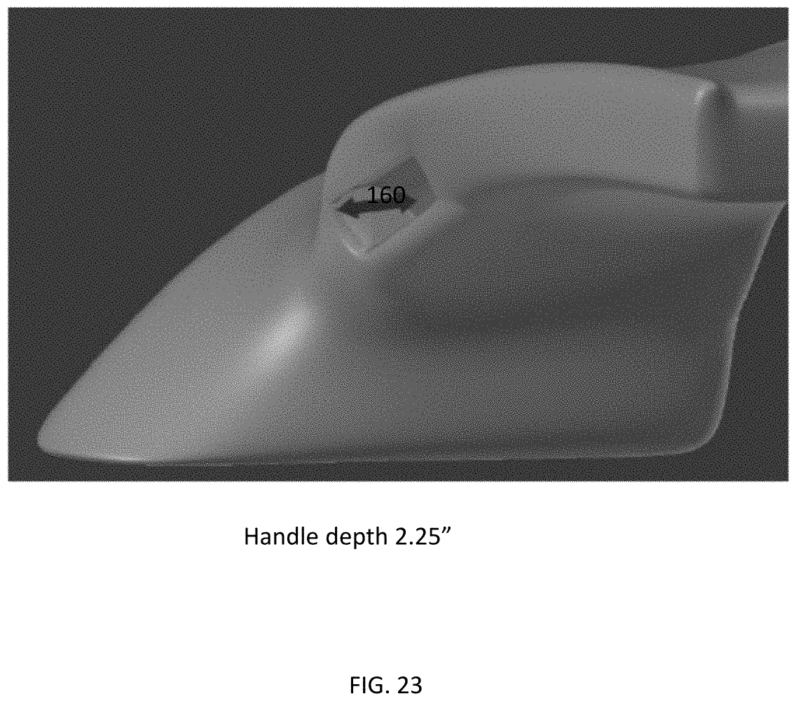

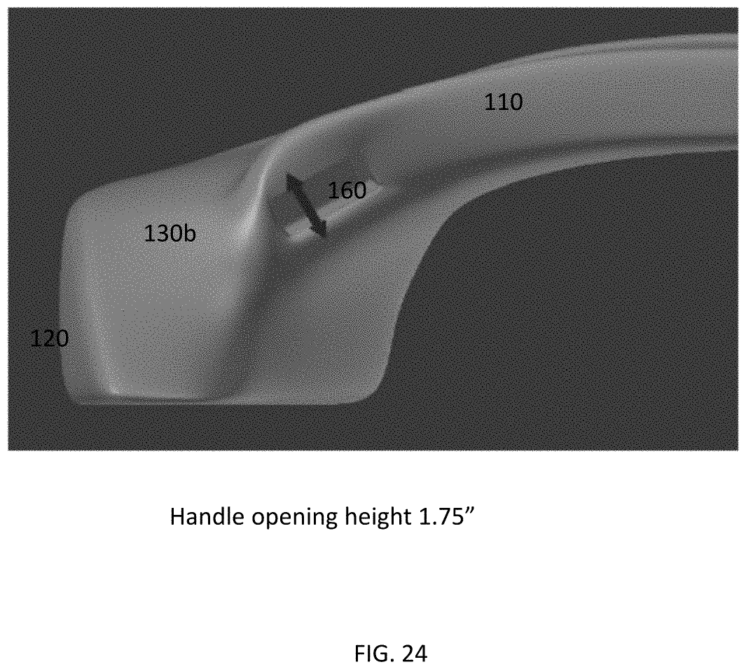

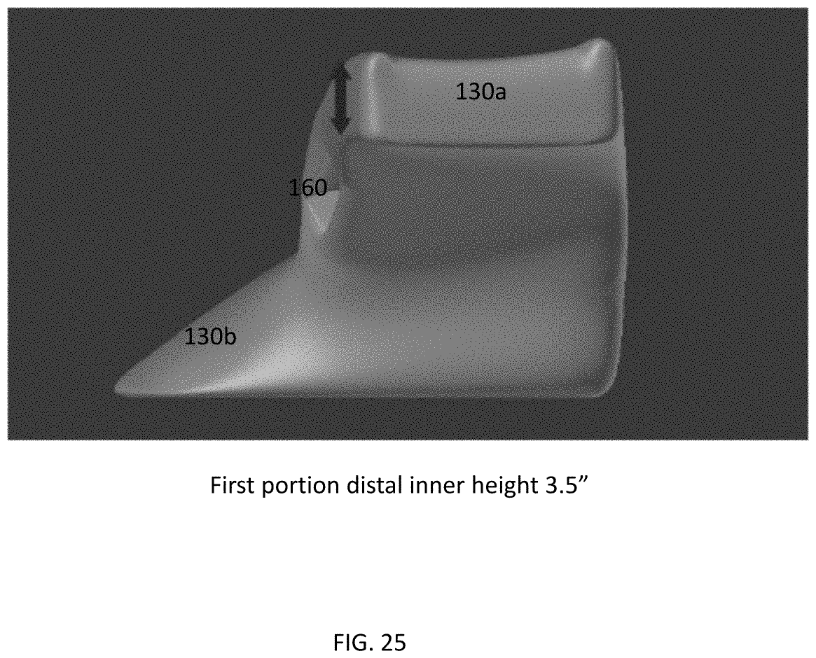

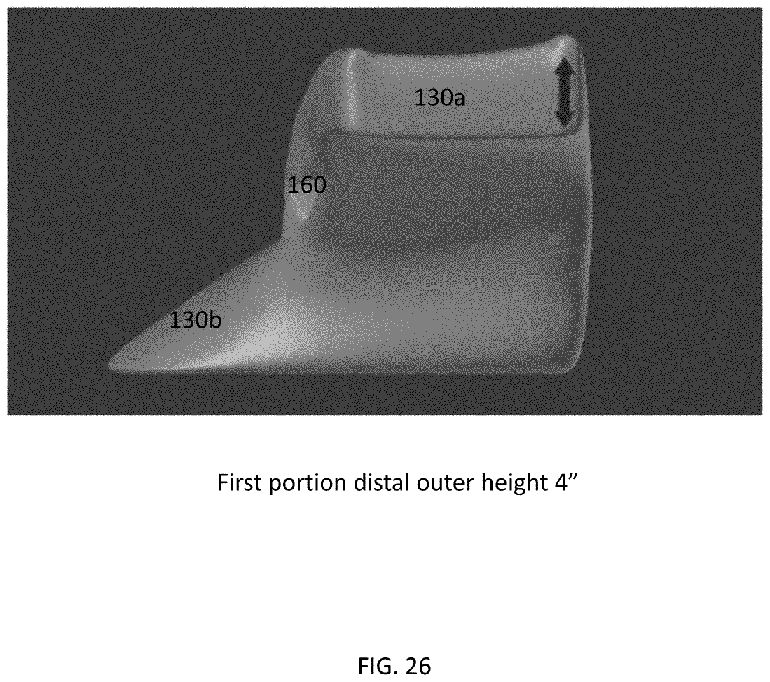

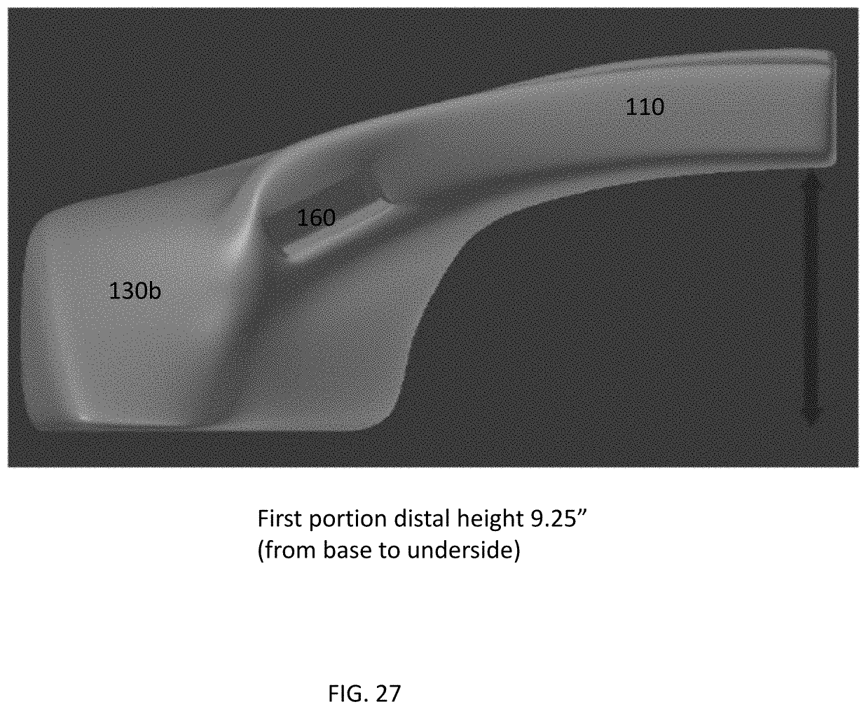

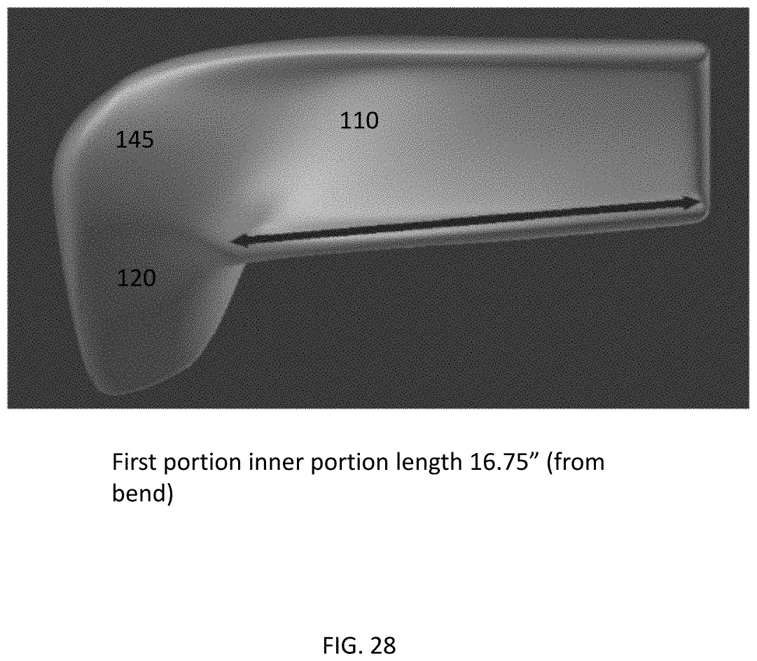

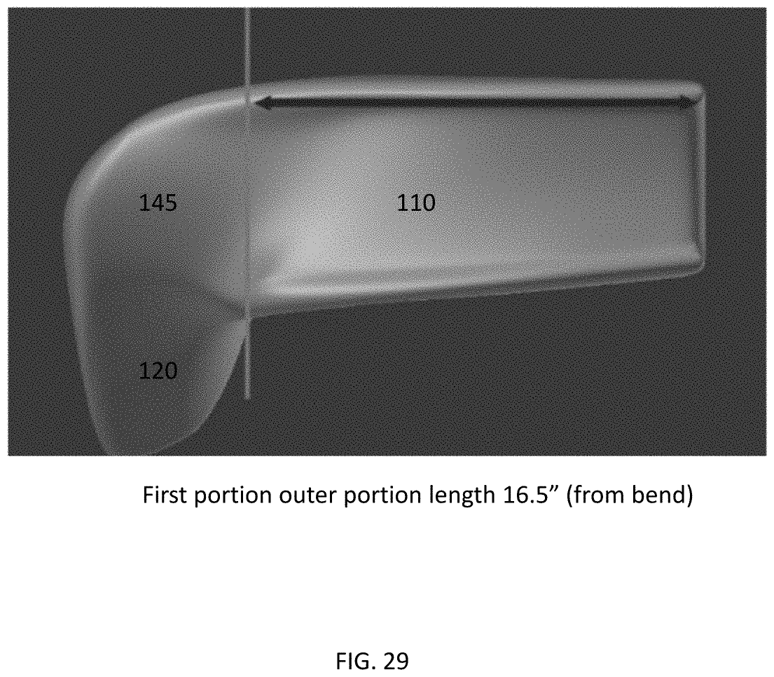

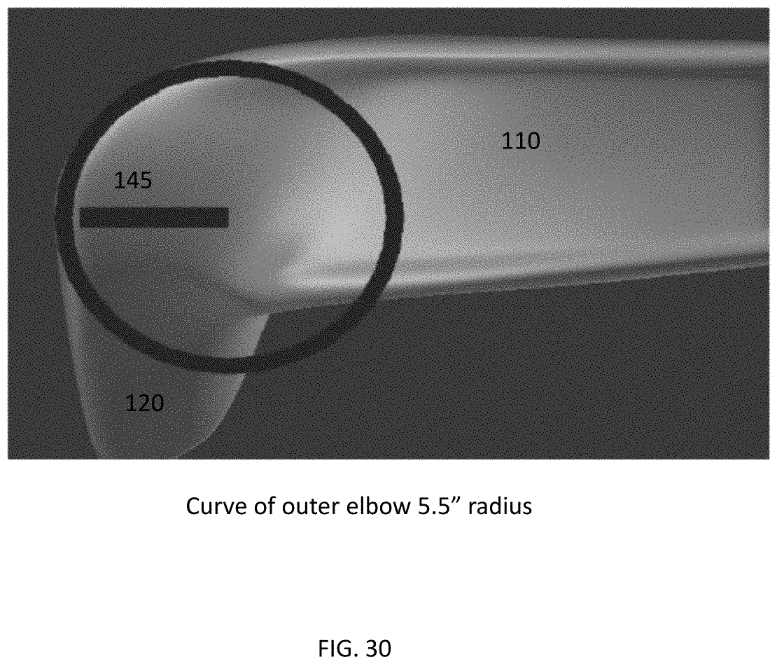

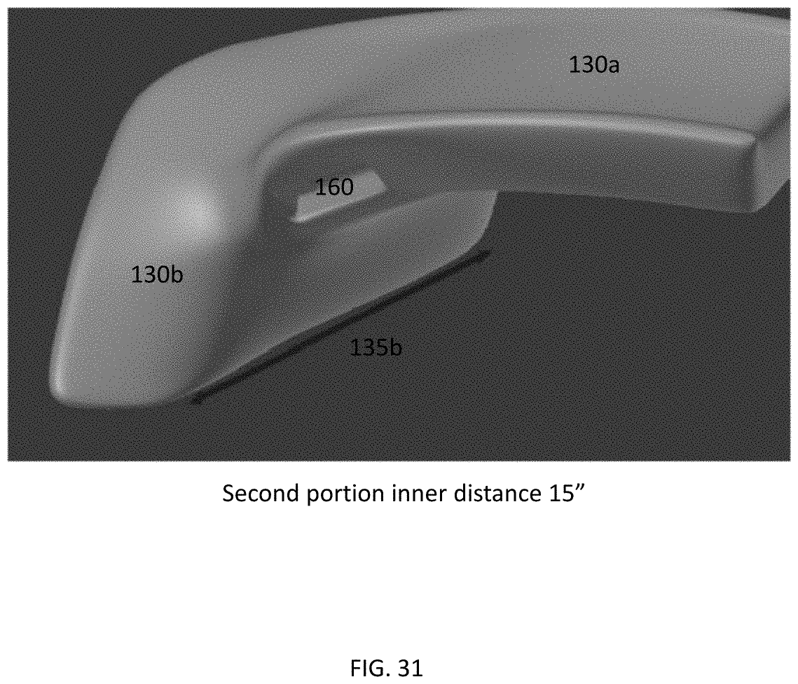

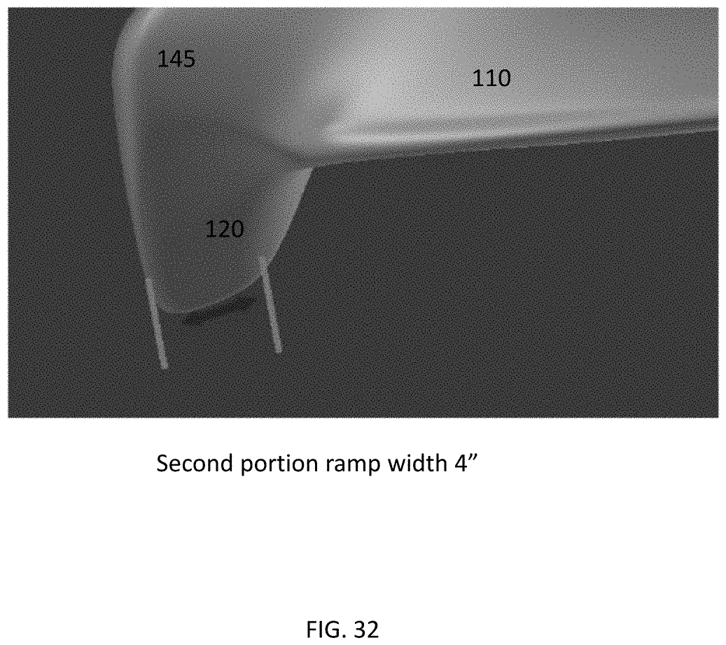

Other design features are apparent in FIGS. 4-5. Referring first to FIG. 4, the support apparatus 100 is configured so that the first portion 110 has a height that is higher than the second portion 120. To achieve this height difference, while maintaining a comfortable position for the individual, the first portion 110 and the second portion 120 is designed on an incline so that the difference in height is achieved gradually and at a comfortable slope. In one embodiment, this incline may be configured to be approximately 40°. Referring now to FIG. 5, the critical angle of the shoulder that the support apparatus 100 is designed to achieve can be clearly seen. Here, the shoulder is held securely in a neutral position due to the fact that the individual's elbow is bent and secured in the range of approximately 90-100°. The lower portion of the individual's arm is allowed to rest on the first portion 110 of the support device 100 and permits the individual to sleep or rest comfortably while lying do % n.

As can be seen from the figure, the indentation is deep and wide enough to ensure the walled sides are of sufficient height and width to serve as a sufficient barrier to prevent an individual's arm sliding off the support apparatus. This is a significant improvement over the support pillows of the prior art that have no mechanism for preventing an individual's arm from sliding. Therefore the support device of the present disclosure holds potential for reducing or eliminating the pain and potential re-injury that comes from such sliding, especially while the individual is asleep and not actively holding their arm in position by themselves.

The table below provides exemplary measurements that may constitute one embodiment of the support apparatus of the present disclosure. These measurements are provided for illustrative purposes only and should not be construed as to otherwise limit the potential embodiments of the support apparatus to the extent the same are successful in achieving the natural position of the should as discussed above.

Exemplary Measurements

| | |
|---|---|
| Overall greatest width of support apparatus | Approximately 23″ |
| Overall greatest length of support apparatus | Approximately 15.6″ |
| Overall greatest height of support apparatus | Approximately 13.5″ |
| Elbow angle achieved for the individual | In the range of approximately |
| | 90°-100° |
| Slope angle from top of first portion to bottom of | Approximately 40° |
| second portion | |
| Slope angle of incline of the second portion | Approximately 30° |
| Elbow corner outer height | Approximately 7.75″ |
| Elbow corner inner height | Approximately 9.5″ |
| Depth of first portion | In the range of approximately |
| | 7.5″-9.5″ (includes 1″ wide |
| | raised side walls) |
| Raised side walls height | Approximately 0.5″ |
| Handle opening width | Approximately 4″ |
| Handle depth | Approximately 2.25″ |
| Handle opening height | Approximately 1.75″ |
| First portion distal inner height | Approximately 3.5″ |
| First portion outer height | Approximately 4″ |
| First portion distal height | Approximately 9.25″ |
| First portion inner portion length | Approximately 16.75″ |
| First portion outer portion length | Approximately 16.5″ |
| Curve of outer elbow | Approximately 5.5″ radius |
| Second portion inner distance | Approximately 15″ |
| Second portion ramp width | Approximately 4″ |

The support apparatus of the present disclosure is unique in that it positions the shoulder, and in particular the glenohumeral joint, in a neutral position. Such a position not only enables the individual to relax, but also maintains proper positioning of the shoulder to promote healing and recovery after surgery or injury. Due to the complexity of the shoulder, and the glenohumeral joint in particular, current pillow and sling designs fail to simultaneously achieve both proper positioning of the shoulder and relaxation for the individual. The support apparatus disclosed herein overcomes the limitations of the prior art by providing a novel design that achieves both a neutral shoulder position and a position that is comfortable enough for an individual to sleep or rest lying down. Such a design enables the individual to sleep or rest in their own bed without any other modifications or pillows. This is a great improvement over current pillow and sling designs which require an individual to sleep or rest in a chair which is not only uncomfortable but also risks the shoulder falling out of proper positioning.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the embodiments of the disclosure, it is noted that other variations and modification will be apparent to those skilled in the art, and may be made without departing from the spirit or scope of the disclosure.

What is claimed is:

1. A support apparatus comprising:
a first portion configured to rest across the midsection of an individual's body while the individual is in a supine position;
a second portion configured to rest alongside an individual's upper body;
wherein the first portion and the second portion both comprise a top surface and a bottom surface;
wherein at least one of the top surface of the first portion and the top surface of the second portion are further indented to receive one or more parts of the individual's arm; and
wherein the bottom surface of the first portion is further indented to receive the individual's midsection.

2. The support apparatus of claim 1 wherein the support apparatus is further comprised of at least one foam material.

3. The support apparatus of claim 1 wherein the first portion and the second portion are joined at an angle that permits the individual's elbow to rest in a bent position of approximately 95°.

4. The support apparatus of claim 1 wherein the first portion and the second portion are joined at an angle that permits the individual's elbow to rest in a bent position in the range of approximately 90°-100°.

5. The support apparatus of claim 1 wherein the first portion has a height that is higher than the second portion.

6. The support apparatus of claim 5 wherein to achieve the difference in height between the first portion and the second portion, the second portion is configured on an incline.

7. The support apparatus of claim 6 wherein the incline of the second portion is approximately 40°.

8. The support apparatus of claim 1 wherein configuration of the first portion and the section portion of the support apparatus further enables the individual's shoulder to be positioned in a neutral position.

9. The support apparatus of claim 8 wherein the neutral position further comprises a position of approximately 55° abduction, 30° horizontal adduction, and neutral rotation.

10. The support apparatus of claim 1 further comprising at least one handle affixed to at least one of the first portion and the second portion.

11. The support apparatus of claim 1 further comprising at least one lift mechanism, wherein the lift mechanism is affixed to the bottom surface of the second portion.

12. A support apparatus comprising:
a first portion configured to rest across the midsection of an individual's body while the individual is in a supine position;
a second portion configured to rest alongside an individual's upper body;
wherein the first portion and the second portion are joined at an angle that permits the individual's elbow to rest in a bent position of approximately 90°-100°;
wherein the first portion has a height that is higher than the second portion;
wherein the second portion is configured on an incline to achieve the difference in height between the first portion and the second portion;
wherein the first portion and the second portion both comprise a top surface and a bottom surface;
wherein at least one of the top surface of the first portion and the top surface of the second portion are further indented to receive one or more parts of the individual's arm;
wherein the bottom surface of the first portion is further indented to receive the individual's midsection; and
wherein the support apparatus enables the individual's shoulder to be positioned in a neutral position.

13. The support apparatus of claim 12 wherein the incline of the second portion is approximately 40°.

14. The support apparatus of claim 12 wherein the neutral position further comprises a position of approximately 55° abduction, 30° horizontal adduction, and neutral rotation.
